(19) United States
(12) Patent Application Publication
(10) Pub. No.: US 2006/0180516 A1
(43) Pub. Date: Aug. 17, 2006

(54) Paper sheet processing apparatus and method

(75) Inventor: Akihiro Yui, Yokosuka-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/219,908

(22) Filed: Sep. 7, 2005

(30) Foreign Application Priority Data
Sep. 28, 2004 (JP) 2004-282756

(51) Int. Cl. B07C 5/00; B65G 57/00

(52) U.S. Cl. 209/553; 414/788.9

(57) ABSTRACT

A paper sheet processing apparatus has a judgment device which judges whether the paper sheets transferred on a transfer path are damaged or not based on the states of the transferred paper sheets, a stacking box which stacks the paper sheets judged damaged with the judgment device, and a pusher which pushes repeatedly the paper sheets stacked in the stacking box toward the inside bottom of the stacking box each time the stack height reaches a predetermined value.

### CROSS-REFERENCE TO RELATED APPLICATIONS

This application is based upon and claims the benefit of priority from prior Japanese Patent Application No. 2004-282756, filed Sep. 28, 2004, the entire contents of which are incorporated herein by reference.

### BACKGROUND OF THE INVENTION

1. Field of the Invention

The present invention relates to a paper sheet processing apparatus for sorting and stacking paper sheets, for example, paper money in several stacking boxes based on the denominations and whether normal or damaged.

2. Description of the Related Art

A kind of paper sheet processing apparatus has a take-in device for setting paper sheets (hereinafter referred to as cards) in a stacking box in the state of mixing different kinds, front and back sides, true and false cards, and normal and damaged cards, a judgment device for judging the kinds, front and back sides, true and false cards, and normal and damaged cards, and a stacking device for stacking the cards in several stacking boxes based on the judgment results.

In the prior art, all cards except those judged true with the judgment device are stacked in a stacking box for rejected cards (hereinafter referred to as a rejection box). The cards stacked in the rejection box include the ones rejected because of skew during taking in and transfer operations, the ones taken in doubly more than ones sheet, the ones damaged and dirty by adherence of tape, bent corners, tears, holes, wrinkles, stains, scribbling or being wholly deteriorated, and false cards. These cards are all mixed when being stacked.

When the rejection box becomes full, the operator takes out the cards from the rejection box, and sorts the cards that should be handled as normal cards, for example, the cards not stained or damaged in appearance but rejected simply by skew or taking in doubly. These sorted cards are set again in the take-in part for re-processing.

However, in the prior art, the rejected cards are merely stacked in the rejection box, and the rejection box becomes full soon. Especially, when handling many bad quality cards, the rejection box becomes full soon even with a few of cards.

Thus, the operator is busy with taking out the cards from the rejection box. If the taking out the cards is delayed, the machine stops taking in cards, or causes a jam. This extremely decreases the machine availability.

As a measure to solve the above problem, the rejected cards are taken out by two operators, or continuous card processing is avoided and a certain number of cards (500-1000 cards) are handled in one time. But, these measures are not effective.

Another measure is to increase the stacking number of rejected cards by providing several rejection boxes. However, this measure uses a stacking box that is originally used to stack the cards sorted by a processing machine. Further, the number of stacking boxes is limited in small and middle scale machines, and the card sorting and processing efficiency becomes bad.

It is possible to increase the capacity of a rejection box by increasing the depth and width. But, in this case, the next coming card bumps against the card already stacked in the stacking box, causing a jam easily in the rejection box. Thus, the storing state becomes bad, the number of cards stacked in the rejection box cannot be increased, and the processing efficiency is rather decreased.

### BRIEF SUMMARY OF THE INVENTION

The present invention has been made in order to solve the above problems. Accordingly, it is an object of the present invention to provide a paper sheet processing apparatus, which decreases the frequency of filling a rejection box by increasing the number of paper sheets to be stacked in a stacking box for rejection, thereby lightening the operator's load, and increasing the processing efficiency and machine availability very much.

According to a first aspect of the present invention, there is provided a paper sheet processing apparatus comprising a setting unit which sets paper sheets, a take-in device which takes in the paper sheets set in the setting unit, a transfer device which transfers the paper sheets taken in with the take-in device, a judgment device which judges whether the paper sheets transferred with the transfer device are damaged or not based on the states of the transferred paper sheets, a stacking device which stacks the paper sheets judged damaged with the judgment device, and a pushing device which pushes repeatedly the paper sheets stacked in the stacking device toward the inside bottom of the stacking device each time the stack height reaches a predetermined height.

According to a second aspect of the present invention, there is provided a paper sheet processing apparatus comprising a setting unit which sets paper sheets, a take-in device which takes in the paper sheets set in the setting unit (1a), a transfer device which transfers the paper sheets taken in with the take-in device, a judgment device which judges whether the paper sheets transferred with the transfer device are damaged or not based on the states of the transferred paper sheets, a stacking device which stacks the paper sheets judged damaged with the judgment device, a pushing device which pushes the paper sheets stacked in the stacking device out of the stacking device, and a housing device which houses the paper sheets pushed out with the pushing device.

According to the embodiments of the present invention, the stacking number of rejected cards can be much increased, and even if bad quality cards are handled, the frequency of filling the rejection box is much decreased, the operator's load is lightened, and the machine availability is improved.

Additional objects and advantages of the invention will be set forth in description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic diagram showing the whole configuration of a paper sheet processing apparatus according to a first embodiment of the present invention;

FIG. 2 is a block diagram showing a driving control system of sorting gates of the paper sheet processing apparatus of FIG. 1;

FIG. 3 is a flowchart showing the card sorting operation of the paper sheet processing apparatus of FIG. 1;

FIG. 4 is a drawing showing the card stacking operation in a rejection box of the paper sheet processing apparatus of FIG. 1;

FIG. 5 is a block diagram showing a rejection box according to a second embodiment of the present invention;

FIG. 6A is a drawing showing the operation of housing the cards stacked in the rejection box of FIG. 5 into a cassette;

FIG. 6B is a drawing showing the operation of housing the card stacked in the rejection box of FIG. 5 into a cassette;

FIG. 7 is a block diagram showing a rejection box according to a third embodiment of the present invention;

FIG. 8A is a drawing showing the operation of housing the cards stacked in the rejection box of FIG. 7 into a cassette; and

FIG. 8B is a drawing showing the operation of housing the card stacked in the rejection box of FIG. 7 into a cassette.

### DETAILED DESCRIPTION OF THE INVENTION

The present invention will be explained in detail hereinafter with reference to the embodiments shown in the accompanying drawings.

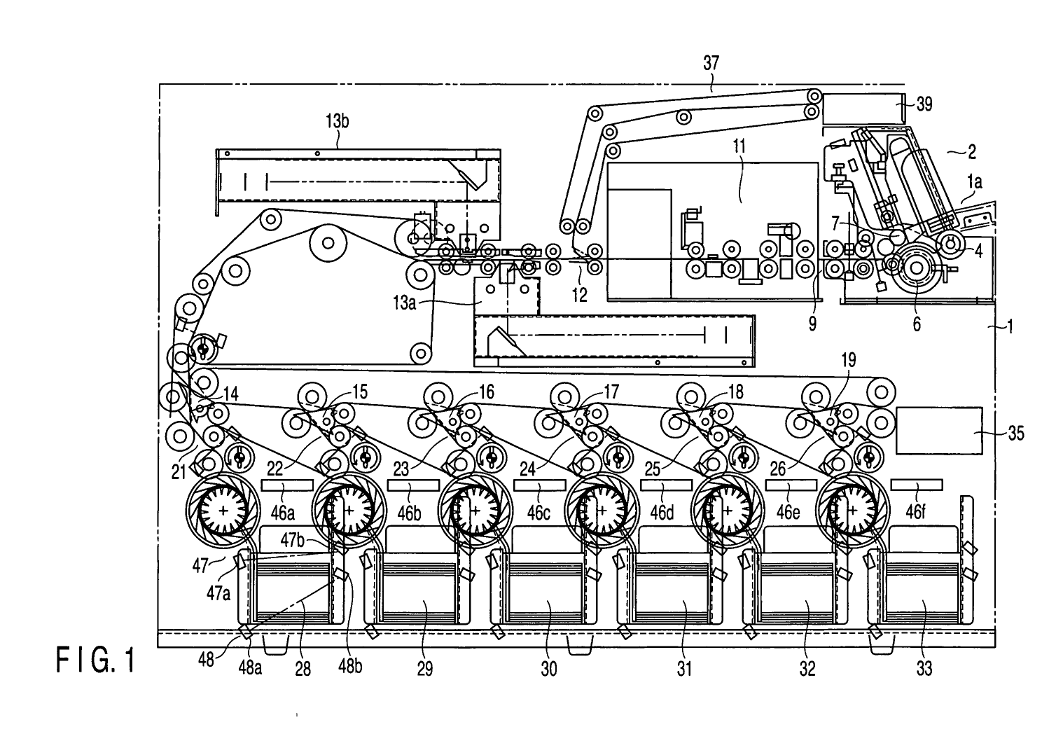

FIG. 1 is a simplified schematic diagram showing a paper money processing machine as a paper sheet processing apparatus according to one embodiment of the present invention.

In FIG. 1, a reference numeral 1 denotes a main body of the machine. On one side of the main body 1, a setting unit 1a is provided, which sets paper money P (hereinafter, referred to as a card) as a paper sheet in a stacked state. The card P set in the setting unit 1a is taken in with a take-in part 2 as a take-in device. The take-in part 2 has a take-in roller 4. In the direction of taking in cards of the take-in roller 4, a feed roller 6 and a separation roller 7 that rollingly contacts the upper side of the feed roller 6 are provided.

The card P fed out from the feed roller 6 is transferred along a transfer path 9 as a transfer device. In the transfer path 9, there are provided a first detector (optical detector) 11, a sorting gate 12, second detectors (CCD optical detectors) 13a, 13b and first to sixth sorting gates 14-19. The first to sixth sorting gates 14-19 guide a card selectively to first to sixth branch paths 21-26. In the card exit side of the first to sixth branch paths 21-26, first to sixth stacking boxes 28-33 are provided as a stacking part.

In the carry-out side of the transfer path 9, a false card stacking box 35 for stacking a false card is provided. In the upper side of the take-in part 2, a return box 39 is provided. The return box 39 stacks a card skewed or taken out doubly and rejected.

On the upper side of the first to sixth stacking boxes 28-33, pushers 46a-46f as a pushing device are provided movably up and down. The first to sixth stacking boxes 28-33 are provided with an optical sensor 47 to detect the full of cards and an optical sensor 48 to detect a remaining card. The optical sensors 47 and 48 consist of light-emitting elements 47a/48a and light-receiving elements 47b/48b to receive the light emitted from the light-emitting elements 47a/48a.

When the cards stacked in the first to sixth stacking boxes 28-33 exceeds a predetermined height and detected with the full-detecting optical sensor 47, the pushers 46a-46f are moved down to push the cards to the inside bottom of the first to sixth stacking boxes 28-33.

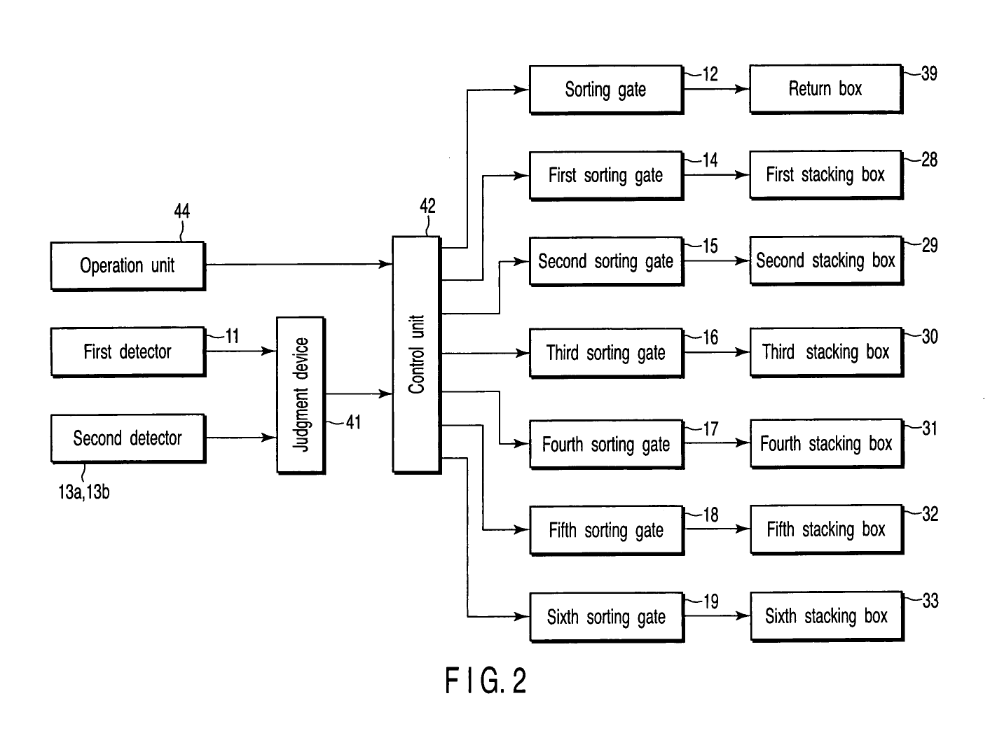

FIG. 2 is a block diagram showing a driving control system of the above-mentioned sorting gate 12 and first to six sorting gates 14-19.

The above-mentioned first and second detectors 11 and 13a, 13b are connected to a judgment device 41 through a transmission circuit to transmit a detection signal. A control unit 42 is connected to the judgment device 41 through a transmission circuit to transmit the result of judgment. The control unit 42 is connected with the sorting gate 12 and first to sixth sorting gates 14-19 through a control circuit. The control unit 42 is also connected with an operation unit 44 through a transmission circuit.

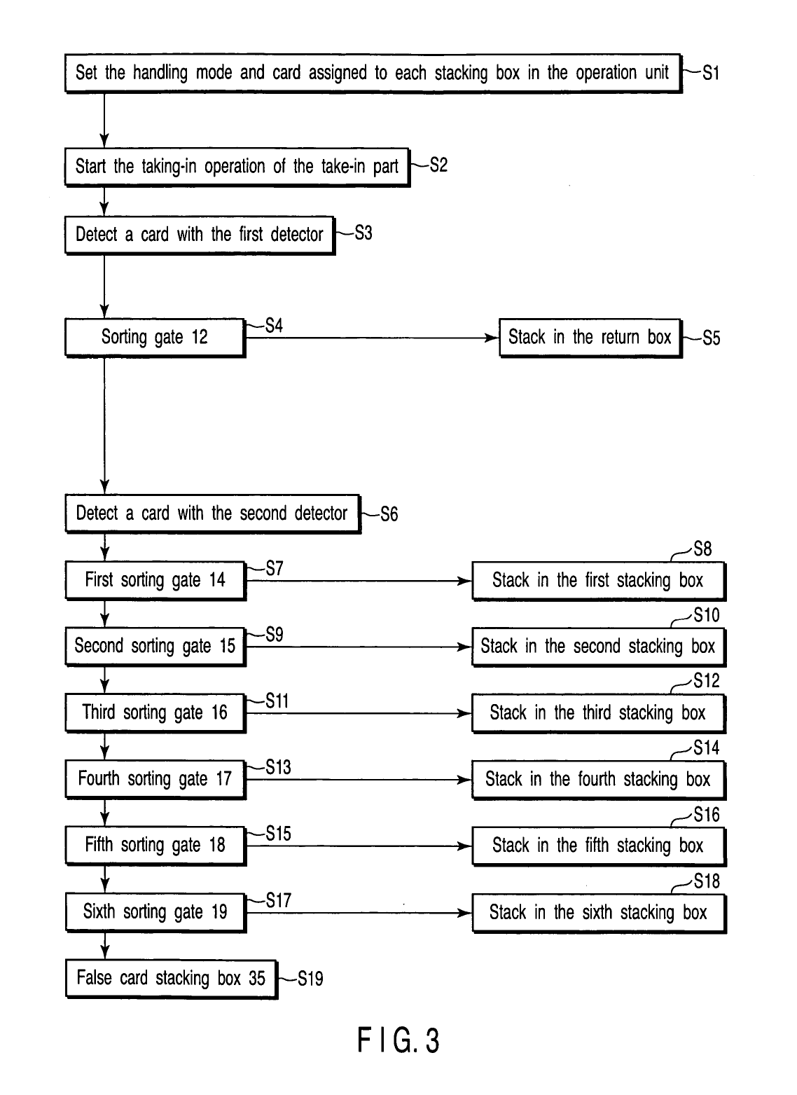

Next, the operation of the paper money processing apparatus described above will be explained with reference to the flowchart of FIG. 3.

First, set a handling mode (assign a stacking box) in the operation unit 44 (or PC). For example, set the second to sixth stacking boxes 29-33 for normal cards, and the first stacking box 28 for rejected cards. (Hereinafter, the first stacking box 28 is referred to as a rejection box 28). The rejection box stacks the cards damaged by adhesion of tape, bent corner, tear, hole and dirty cards (stain, scribbling, partial or whole deterioration).

After the setting, the take-in roller 4 of the take-in part is moved rotationally and a card P is taken in (step S2). The card is separated and fed one by one with the feed roller 6 and separation roller 7. The card is transferred along the transfer path 9. The first detector 11 detects the thickness of the card, and optically and magnetically detects the shape and contents of the card (step S3). The judgment device 41 judges the card true or false based on the detected information, and determines whether the card is skewed or taken in doubly more than one.

The card judged skewed or taken in doubly more than one is sorted to the return path 37 through the sorting gate 12 (step S4), and returned to the return box 39 through the return path 37 (step 5).

The card judged not skewed or taken in doubly more than one is sorted by the sorting gate 12, and sent to the second detectors 13a and 13b to be optically detected (step S6). Based on the detected information, the kinds, front and back sides, true and false, and normal and damaged (discrimination between normal and damaged cards) are judged.

The card judged damaged (adhesion of tape, hole, scribbling, or stain) is sorted by the first sorting gate 14 (step S7), and stacked in the rejection box 28 (step S8).

When a card is judged false, the first to sixth gates 14-19 are not operated, and the card is ejected from the exit end of the transfer path 9 and stacked in the false card stacking box 35 (step 19).

Next, an explanation will be given on the operation of pushing the cards stacked in the rejection box 28 as described above.

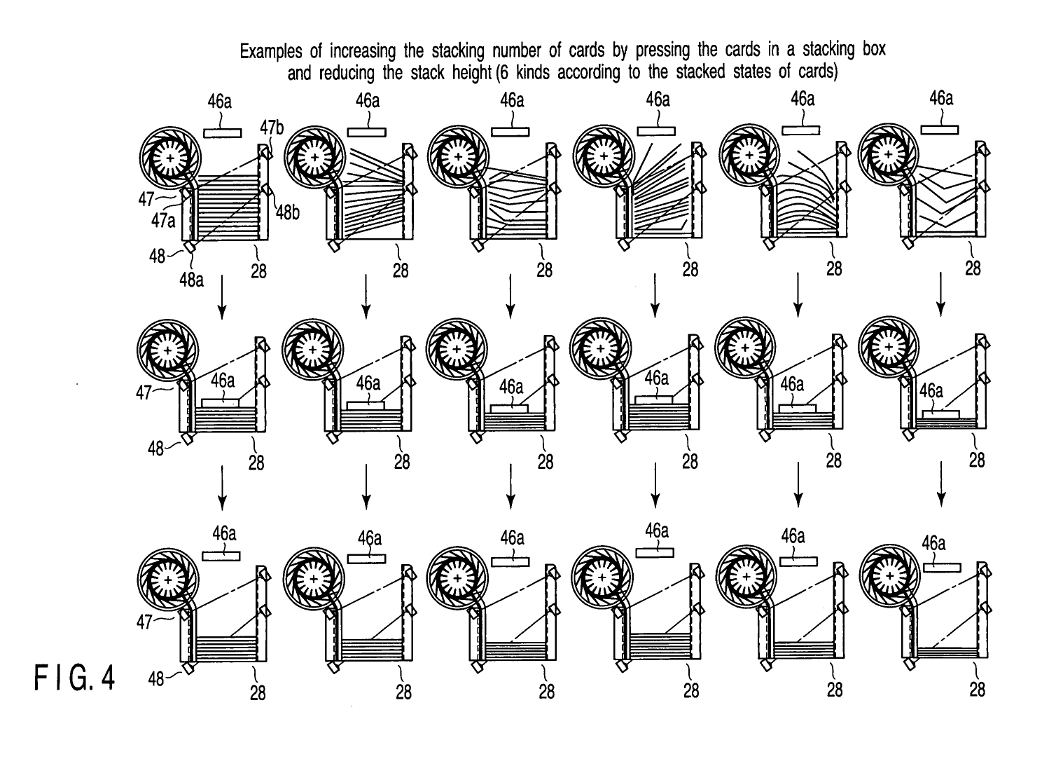

FIG. 4 shows six states of cards stacked in the rejection box 28. As shown in FIG. 4, the rejected cards stacked in the rejection box 28 include a card damaged by bent corner or a curled card, and the stacked state is often bad. Thus, even if the number of stacked cards is a few, the stacked height exceeds a predetermined height, and shades the optical sensor 47 for detecting being full of cards.

However, in this embodiment, when card-full is detected, the pusher 46a moves down and pushes the stacked cards to the inside bottom of the first stacking box 28 to compress the stack and reduce the stacked height. After pushing the cards, the pusher 46a moves back to the initial position. By the pushing of the pusher 46a, the full state is reset and more cards can be stacked in the first stacking box 28.

The above-mentioned pushing operation by the pusher 46a is not only once, but repeated by appropriate times until the full state is not reset.

As described above, each time the rejected cards stacked in the rejection box 28 reaches a predetermined height, the stacked cards are pushed repeatedly by the pusher 46, and the number of stacked cards can be increased by compressing the stacked height regardless of the states of the cards.

Therefore, the frequency that the rejection box 28 becomes full is much decreased, the number of times that the operator takes out the cards from the rejection box 28 is reduced, and the operation load is lightened, thereby improving the processing efficiency and machine availability.

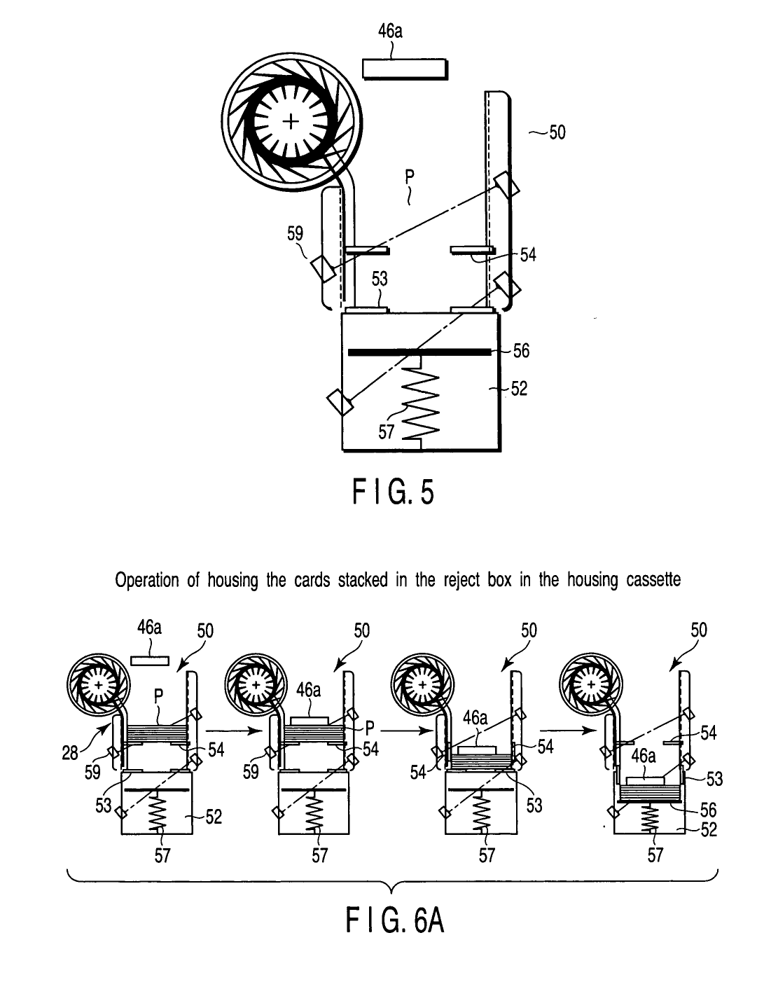

FIG. 5 is a block diagram showing a rejection box 50 according to a second embodiment of the present invention.

The same reference numerals are given to the same parts as those explained in the first embodiment, and explanation will be omitted.

The rejection box 50 has a cassette 52 as a housing device at the bottom. The interior of the rejection box 50 connects with the interior of the cassette 52. A first lever 53 is provided rotatably at the bottom of the rejection box 50. A second lever 54 is provided rotatably above the first lever 53. A backup plate 56 is provided inside the cassette 52. The backup plate 56 is elastically supported by a spring 57.

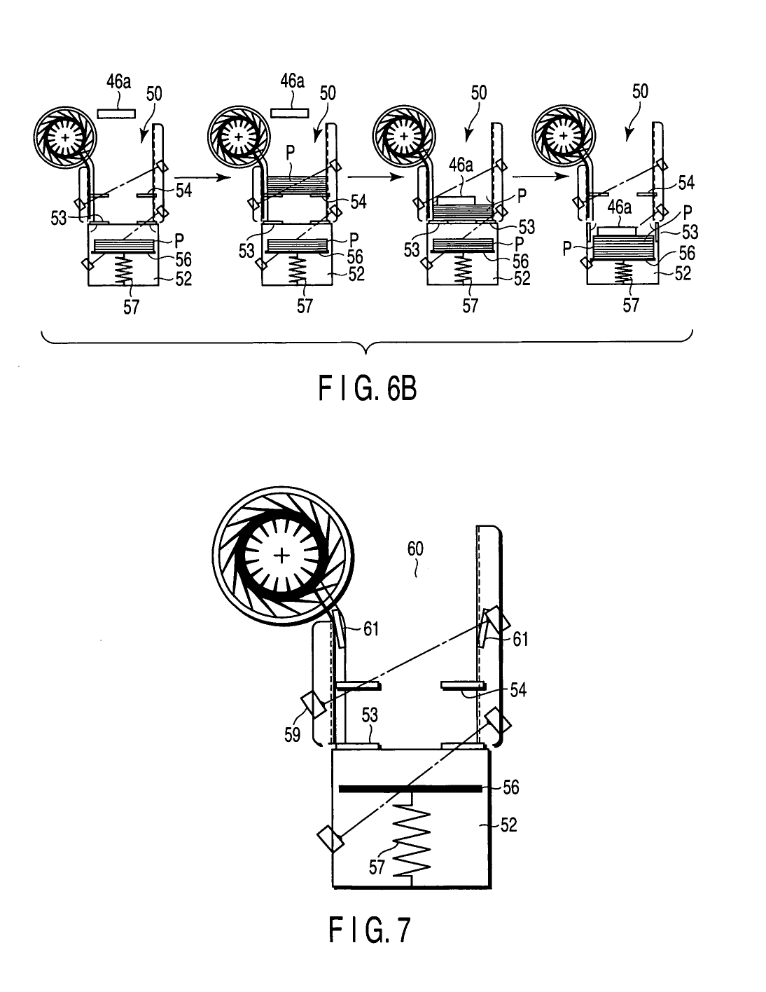

Next, explanation will be given on the stacking of rejected cards in the first stacking box 28 and housing of the cards in the cassette 52 with reference to FIG. 6A and FIG. 6B.

First, as shown in FIG. 6A, a card P thrown into the rejection box 28 is stacked on the second lever 54. The stacked card P is detected by the detection sensor 59. When the take-in operation of the take-in part 2 is stopped after the detection of the card P, the pusher 46a is moved down to push down the card P. Thus, the second lever 54 is moved rotationally 900 downward to shift the card P onto the first lever 53.

The pusher 46a is moved down further to press the card P. Thus, the card P is housed in the cassette 52, and shifted onto the backup plate 56. The pusher 46a is moved up to return to the initial position, as shown in FIG. 6B. Then, another card P is thrown into the rejection box 28, and stacked on the second lever 54.

The card P stacked on the second lever 54 is pushed down and stacked on the first lever 43 as described above, and the card is pressed and housed in the cassette 52 and shifted onto the card P stacked on the backup plate 56.

According to the second embodiment, the card stacked in the rejection box 50 is compressed and housed in the cassette 52 for housing a rejected card, and the housing number of rejected cards can be much increased.

FIG. 7 is a block diagram showing a rejection box 60 according to a third embodiment of the present invention.

The same reference numerals are given to the same parts as those explained in the second embodiment, and an explanation will be omitted.

The rejection box 60 has a third lever 61 above the second lever 54. The third lever 61 and second lever 54 are provided rotatably and movable up and down.

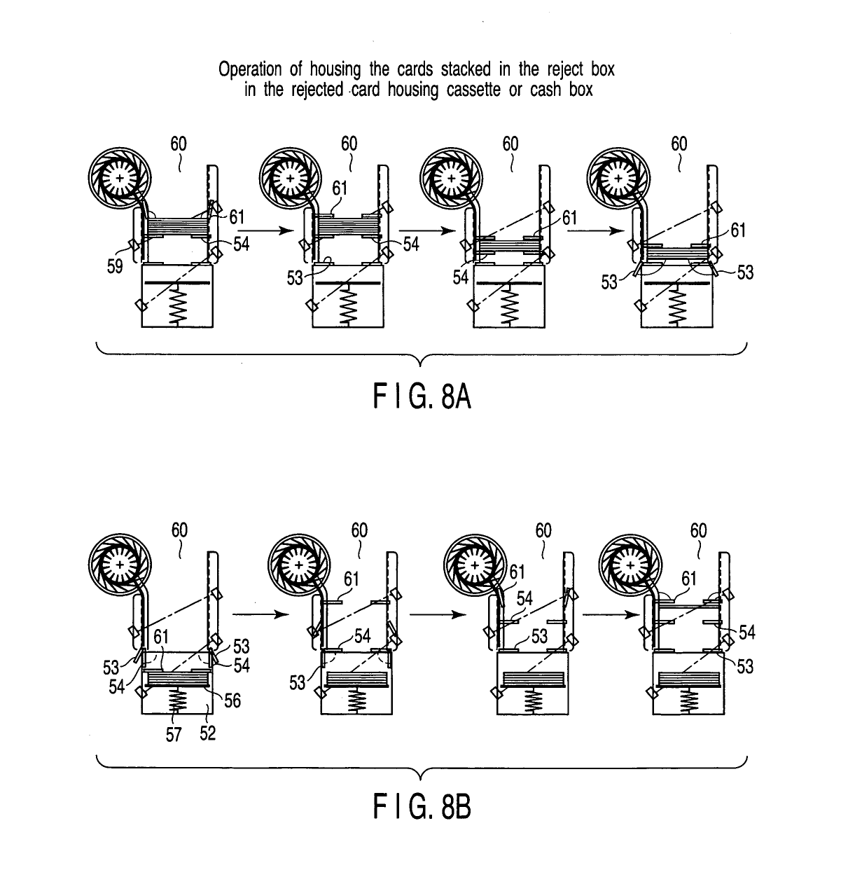

Next, explanation will be given on the stacking of rejected cards in the rejection box 60 and housing of the cards in the cassette 52 with reference to FIG. 8A and FIG. 8B.

As shown in FIG. 8A, a card P thrown into the rejection box 60 is stacked on the second lever 54. The stacked card P is detected by the detection sensor 59. When the take-in operation of the take-in part 2 is stopped after the detection of the card P, the third lever 61 is moved rotationally to hold the card P together with the second lever 54. Then, the second and third levers 54 and 61 are moved down, and the first lever 53 is moved rotationally downward.

Then, as shown in FIG. 8B, the second lever 54 is moved rotationally downward, and the third lever 61 is moved down to press the card P into the cassette 52 and shift the card onto the backup plate 56.

The third lever 61 is moved up and returned to the initial position, and the second lever is moved rotationally to the horizontal state. Then, the third lever 61 is moved rotationally and retreated just like along the inside surface of the box, the second lever 54 is moved up, and the first lever 53 is moved horizontally.

From this state, another card P is thrown into the rejection box 60, and held by the second lever 54 and third lever 61. The same operation is repeated, and the card P is pressed and housed in the cassette 52.

According to the third embodiment, the same effects as the second embodiment can be obtained.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A paper sheet processing apparatus comprising:
a setting unit which sets paper sheets;
a take-in device which takes in the paper sheets set in the setting unit;
a transfer device which transfers the paper sheets taken in with the take-in device;
a judgment device which judges whether the paper sheets transferred with the transfer device are damaged or not based on the states of the transferred paper sheets;
a stacking device which stacks the paper sheets judged damaged with the judgment device; and
a pushing device which pushes repeatedly the paper sheets stacked in the stacking device toward the inside bottom of the stacking device each time the stack height reaches a predetermined value.

2. The paper sheet processing apparatus according to claim 1, further comprising a detection sensor which detects that the paper sheets stacked in the stacking device reach a predetermined height, wherein the pushing device is operated based on the detection of the predetermined height by the detection sensor.

3. The paper sheet processing apparatus according to claim 1, wherein the pushing device is a pusher which reciprocates along the paper sheet stacking direction.

4. A paper sheet processing apparatus comprising:
a setting unit which sets paper sheets;
a take-in device which takes in the paper sheets set in the setting unit;
a transfer device which transfers the paper sheets taken in with the take-in device;
a judgment device which judges whether the paper sheets transferred with the transfer device are damaged or not based on the states of the transferred paper sheets;
a stacking device which stacks the paper sheets judged damaged with the judgment device;
pushing devices which push the paper sheets stacked in the stacking device out of the stacking device; and
a housing device which houses the paper sheets pushed out with the pushing devices.

5. The paper sheet processing apparatus according to claim 4, further comprising a detection sensor which detects the paper sheets stacked in the stacking device, wherein the pushing devices are operated based on the end of the taking-in operation by the take-in device, after the detection sensor detects the stacked paper sheets.

6. The paper sheet processing apparatus according to claim 4, wherein the pushing device is a pusher which reciprocates along the paper sheet stacking direction.

7. The paper sheet processing apparatus according to claim 4, the pushing devices are a holding levers to hold the stacked paper sheets, and the paper sheets are pushed out by the movement of the holding levers.

8. A paper sheet processing method comprising:
setting paper sheets in a setting unit;
taking in the paper sheets set in the setting unit with a take-in device;
transferring the paper sheets taken in with the take-in device with a transfer device;
judging whether the paper sheets transferred with the transfer device are damaged or not with a judgment device, based on the states of the transferred paper sheets;
stacking the paper sheets judged damaged with the judgment device in a stacking device; and
pushing repeatedly the paper sheets stacked in the stacking device toward the inside bottom of the stacking device with a pushing device each time the stack height reaches a predetermined value.

9. The paper sheet processing method according to claim 8, wherein a detection sensor detects that the paper sheets stacked in the stacking device reach a predetermined height, and the pushing device is operated based on the detection of the predetermined height by the detection sensor.

10. The paper sheet processing method according to claim 8, wherein the pushing device is a pusher which reciprocates along the paper sheet stacking direction.

11. A paper sheet processing method comprising:
setting paper sheets in a setting unit;
taking in the paper sheets set in the setting unit with a take-in device;
transferring the paper sheets taken in with the take-in device with a transfer device;
judging whether the paper sheets transferred with the transfer device are damaged or not with a judgment device, based on the states of the transferred paper sheets;
stacking the paper sheets judged damaged with the judgment device in a stacking device;
pushing the paper sheets stacked in the stacking device out of the stacking device with pushing devices; and
housing the paper sheets pushed out with the pushing devices in a housing device.

12. The paper sheet processing method according to claim 11, wherein a detection sensor detects the paper sheets stacked in the stacking device, and the pushing devices are operated based on the end of the taking-in operation by the take-in device, after the detection sensor detects the stacked paper sheets.

13. The paper sheet processing method according to claim 11, wherein the pushing device is a pusher which reciprocates along the paper sheet stacking direction.

14. The paper sheet processing method according to claim 11, the pushing devices are holding levers to hold the stacked paper sheets, and the paper sheets are pushed out by the movement of the holding levers.
